(19) United States
(12) Patent Application Publication
(10) Pub. No.: US 2016/0208125 A1
(43) Pub. Date: Jul. 21, 2016

(54) HARD CAPSULE

(71) Applicant: SAMSUNG FINE CHEMICALS CO., LTD., Ulsan (KR)

(72) Inventors: Jin Ryul SON, Incheon (KR); Kil Seuk BYUN, Yongin-si (KR)

(21) Appl. No.: 14/442,563

(22) PCT Filed: Jul. 16, 2013
(86) PCT No.: PCT/KR2013/006337

§ 371 Date: May 13, 2015

(51) Int. Cl. C09D 101/28

(52) U.S. Cl. CPC C09D 101/28; C09D 101/284

(57) ABSTRACT

Provided is a hard capsule. The provided hard capsule includes a water-soluble cellulose ether and a gelation agent, wherein an amount of the gelation agent is about 0.5 parts by weight to about 1.5 parts by weight based on 100 parts by weight of the water-soluble cellulose ether, and further includes 0 parts by weight to about 0.3 parts by weight of a gelation aid based on 100 parts by weight of the water-soluble cellulose ether.

### TECHNICAL FIELD

The present invention relates to a hard capsule, and more particularly, to a hard capsule having a low manufacturing cost, high homogeneity, and a low haze.

### BACKGROUND ART

In general, hard capsules are prepared by using gelatin derived from bovine animal or swine.

Gelatin-containing aqueous compositions are prepared in a relatively short period of time due to the possibility of the direct dissolution of gelatin in high-temperature water (for example, 60° C.), and when a mold pin is immersed therein and then taken therefrom to dry the gelatin-containing aqueous compositions coated on the mold pin, the drying time is short, the obtained hard capsule may have excellent elasticity, glossiness, and disintegrability, and the production yield of the hard capsule is very high. However, a concern on the mad cow disease has limited the use of gelatin capsules, and accordingly, capsules prepared by using a plant-based cellulose ether, instead of the gelatin, are getting much attention.

However, although cellulose ether dissolves in room temperature (25° C.) water, as soon as the cellulose ether is added to water, most of the cellulose ether aggregates to form an aggregate, thus requiring a long time for complete dissolution. To prevent this problem, when an aqueous composition for preparing a hard capsule is prepared, the cellulose ether is added to high temperature (for example, 80° C. or higher) water to prevent the aggregation and then dispersed well to prepare a dispersion. Then, the dispersion is naturally cooled down to a first temperature (for example, about 40° C. to about 50° C.) to dissolve the dispersed cellulose ether in water. Thereafter, the resultant is heated to a second temperature (for example, about 55° C. to about 65° C.), and then a gelation agent and optionally a gelation aid are added to the resultant. In this regard, the heating of the resultant to the second temperature is performed to prevent solidification of the gelation agent and the gelation aid. However, cellulose ether may not be completely dissolved in water at the second temperature, and thus an aqueous composition and a final hard capsule, including the cellulose ether, may have the following disadvantages:

(1) the aqueous composition may have a varying viscosity according to location and may also undergo a layer-separation during a long-term storage;

(2) a degree of mixing of a cellulose ether and a gelation agent (and optionally, a gelation aid) in the aqueous composition may decrease, thereby requiring more gelation agent (and optionally, a gelation aid) to be added thereto;

(3) the aqueous composition may have a low filtering efficiency in a subsequent filtering process for removing foreign materials (for example, fiber) therefrom;

(4) even after the filtering process, foreign materials may remain in the aqueous composition to deteriorate the performance of a capsulation agent and/or a capsulation aid, leading to a decrease in capsule moldability or formability;

(5) when a drying process is performed to evaporate water in the aqueous composition coated on a substrate (for example, a mold pin) in a capsule molding process, a drying rate of the aqueous composition is low;

(6) the preparation time and drying time of the aqueous composition are long, and thus, the production yield of a hard capsule is low; and

(7) foreign materials remaining in the aqueous composition are included in a hard capsule, which is a final product, and due to the included foreign materials, the quality (elasticity, glossiness, disintegrability, or the like) of the hard capsule decreases, and it is difficult to keep the quality of a hard capsule constant for all production lots.

### DETAILED DESCRIPTION OF THE INVENTIVE CONCEPT

### Technical Problem

The present invention provides a hard capsule having a low manufacturing cost, high homogeneity, and a low haze.

### Technical Solution

According to an aspect of the present invention, there is provided a hard capsule including a water-soluble cellulose ether and a gelation agent, wherein an amount of the gelation agent is about 0.5 parts by weight to about 1.5 parts by weight based on 100 parts by weight of the water-soluble cellulose ether, and further comprising 0 parts by weight to about 0.3 parts by weight of a gelation aid based on 100 parts by weight of the water-soluble cellulose ether.

The hard capsule may further comprise 0 parts by weight to about 5 parts by weight of other additives based on 100 parts by weight of the water-soluble cellulose ether.

The water-soluble cellulose ether may include hydroxypropyl methylcellulose (HPMC), hydroxyethyl methylcellulose (HEMC), methylcellulose (MC), or a mixture of two or more of these.

The gelation agent may include Carrageenan, Gellan gum, Xanthan gum, Pectin, or a mixture of two or more of these.

The gelation aid may include potassium chloride, potassium acetate, calcium chloride, or a mixture of two or more of these.

The other additives may include a plasticizer, an emulsifier, or a mixture of two or more of these.

### Advantageous Effects

A hard capsule according to an embodiment of the present invention has excellent gel performance and low haze despite including a small amount of gelation agent.

### BEST MODE

Hereinafter, a hard capsule according to an embodiment of the present invention is described in detail.

A hard capsule according to an embodiment of the present invention includes a water-soluble cellulose ether and a gelation agent, wherein an amount of the gelation agent is about 0.5 parts by weight to about 1.5 parts by weight based on 100 parts by weight of the water-soluble cellulose ether, and further includes about 0 parts by weight to about 0.3 parts by weight of a gelation aid based on 100 parts by weight of the water-soluble ether.

The hard capsule may be prepared by using an aqueous composition for preparing a hard capsule having a composition described below.

The aqueous composition for preparing a hard capsule includes the water-soluble cellulose ether, gelation agent, alcohol, and water, wherein an amount of the gelation agent may be about 0.5 parts by weight to about 1.5 parts by weight based on 100 parts by weight of the water-soluble cellulose ether. When the amount of the gelation agent is less than 0.5 parts by weight based on 100 parts by weight of the water-soluble cellulose ether, the aqueous composition for preparing a hard capsule may not sufficiently gel during a heat treatment, which may reduce capsule moldability. When the amount of the gelation agent exceeds 1.5 parts by weight, not only does manufacturing cost of the aqueous composition for preparing a hard capsule increase, but viscosity and gelation ability of the aqueous composition for preparing a hard capsule increase excessively, which may cause a low elongation at break and high brittleness of a hard capsule, reduce flowability of the aqueous composition for preparing a hard capsule, and thereby a hard capsule having a nonuniform film thickness may be obtained.

Also, the aqueous composition for preparing a hard capsule may not include the gelation aid or may further include 0.3 parts by weight or less of the gelation aid based on 100 parts by weight of the water-soluble cellulose ether.

When the amount of the gelation aid exceeds 0.3 parts by weight based on 100 parts by weight of the water-soluble cellulose ether, a hard capsule having a high haze and thus a low transparency is obtained.

The water-soluble cellulose ether is a major component of the aqueous composition for preparing a hard capsule. The water-soluble cellulose ether is derived from plant-based cellulose, and is advantageous for being harmless to the human body. The term “cellulose ether” as used herein refers to a cellulose derivative prepared by etherifying a hydroxy group of cellulose by using an etherifying agent.

The water-soluble cellulose ether may include hydroxypropyl methylcellulose (HPMC), hydroxyethyl methylcellulose (HEMC), methylcellulose (MC), or a mixture of two or more of these.

The aqueous composition for preparing a hard capsule may include about 10 wt % to about 25 wt % of the water-soluble cellulose ether.

When the amount of the water-soluble cellulose ether in the aqueous composition for preparing a hard capsule is within this range (about 10 wt % to about 25 wt %), the aqueous composition for preparing a hard capsule may have an appropriate level of viscosity. Thus, bubbles may be easily removed from the aqueous composition, and an appropriate thickness of capsules may be obtained.

The gelation agent performs a role of gelling an aqueous composition for preparing a hard capsule, which is described below.

The gelation agent may include a water-soluble gum.

The water-soluble gum may include Carrageenan, Gellan gum, Xanthan gum, Pectin, or a mixture of two or more of these.

The gelation aid supplements the gellability of the gelation agent to perform the role of improving capsule moldability of the aqueous composition for preparing a hard capsule.

The gelation aid may include potassium chloride, potassium acetate, calcium chloride, or a mixture of two or more of these.

The aqueous composition for preparing a hard capsule may further include 0 parts by weight to about 5.0 parts by weight of other additives based on 100 parts by weight of the water-soluble cellulose ether.

The other additives may include a plasticizer, an emulsifier, or a mixture of two or more of these.

The plasticizer performs a role of improving film strength of the hard capsule prepared from the aqueous composition for preparing a hard capsule.

The plasticizer may include glycerol, sorbitol, propylene glycol, polyethylene glycol, or a mixture of two or more of these.

The amount of the plasticizer may be about 0 wt % to about 5.0 wt % of the aqueous composition for preparing a hard capsule. When the amount of the plasticizer is within this range, a hard capsule having high elongation at break and transparency (hence, low haze) may be obtained.

The emulsifier performs a role of improving capsule moldability of the aqueous composition for preparing a hard capsule.

The emulsifier may include sodium lauryl sulfate (SLS), sucrose esters of fatty acids, or a mixture of these.

The amount of the emulsifier may be about 0 wt % to about 1.0 wt % of the aqueous composition for preparing a hard capsule. When the amount of the emulsifier is within this range, a hard capsule having high quality and harmless to human body may be obtained.

When the amount of the other additives is within the range above (0 parts by weight to about 5 parts by weight), a hard capsule having excellent transparency, quality and safety in human body may be obtained.

The alcohol may help the water-soluble cellulose ether to be liquefied (i.e., dissolved) in the aqueous composition for preparing a hard capsule. This process is described in more detail as follows: when the water-soluble cellulose ether is added to room temperature (20° C. to 30° C.) water, a part of the water-soluble cellulose ether that directly contacts water dissolves, but other parts of the water-soluble cellulose ether that do not directly contact water aggregate to form a lump, and when the water-soluble cellulose ether is added to high temperature (40° C. to 70° C.) water, even the part of the water-soluble cellulose ether that directly contacts water does not dissolve well. However, the alcohol is mixed with water to form an aqueous alcohol solution, and the water-soluble cellulose ether dissolves well not only in a room temperature (20° C. to 30° C.) aqueous alcohol solution, but also in a high temperature (40° C. to 70° C.) aqueous alcohol solution.

The alcohol may include ethanol, methanol, isopropanol, butanol, or a mixture of two or more of these.

The aqueous composition for preparing a hard capsule may include about 5 wt % to about 30 wt % of the alcohol.

When the amount of the alcohol is within this range (about 5 wt % to about 30 wt %), solubility of the cellulose ether increases and an evaporation rate of the alcohol becomes suitable for a capsule preparation, and thus a smooth capsule film without wrinkles may be obtained.

When the aqueous composition for preparing a hard capsule is heated to a capsule molding temperature (40° C. to 70° C.), the water-soluble cellulose ether may be completely dissolved. Due to the complete dissolution of the water-soluble cellulose ether, the aqueous composition for preparing a hard capsule may have the following advantages: a shorter preparation time; higher homogeneity, uniform viscosity and no layer-separation even during a period of long-term storage; uniform viscosity for all production lots; higher capsule moldability due to the absence of undissolved materials (for example, cellulose ether) that suppress performance of a gelation agent (and optionally, a gelation aid); reduction of the amount of a gelation agent (and optionally, gelation aid) added thereto due to a high degree of mixing of the cellulose ether and the gelation agent (and optionally, the gelation aid); a high filtering efficiency in a subsequent filtering process for removing foreign materials from the aqueous composition for preparing a hard capsule; a higher drying rate due to a solvent component (e.g., alcohol) when a drying process of the aqueous composition coated on a substrate (e.g., a mold pin) is performed in a capsule molding process; and a higher production yield of a hard capsule due to shorter preparation time and drying time of the aqueous composition for preparing a hard capsule.

Also, the aqueous composition for preparing a hard capsule includes a small amount of an expensive gelation agent and optionally includes a small amount of a cheap gelation aid that may supplement the gelation ability of the gelation agent such that the aqueous composition for preparing a hard capsule has a low manufacturing cost, high uniformity and gel strength, and a hard capsule having a low haze may be formed.

For example, the hard capsule may be prepared by heating the aqueous composition for preparing a hard capsule to a high temperature (40° C. to 70° C.), immersing a room temperature (20° C. to 30° C.) mold pin in the heated aqueous composition for preparing a hard capsule, and taking out the mold pin from the aqueous composition to dry the aqueous composition coated on the mold pin.

The hard capsule has a high quality (elasticity, glossiness, disintegrability, or the like) due to the absence of a foreign material, such as fiber, in the aqueous composition for preparing a hard capsule, and the quality thereof is kept constant for all production lots.

The hard capsule may be gastric juice soluble.

Hereinafter, a method of preparing the aqueous composition for preparing a hard capsule is described in detail.

The method of preparing the aqueous composition for preparing a hard capsule includes preparing a cellulose ether solution that includes water, an alcohol, and water-soluble cellulose ether, and is maintained at a first temperature (40° C. to 70° C.) that is higher than an atmospheric temperature (0° C. to 39° C.). In detail, the method of preparing the aqueous composition for preparing a hard capsule may include mixing water and an alcohol to prepare an aqueous alcohol solution (S1), heating the aqueous alcohol solution (S2), dissolving water-soluble cellulose ether in the heated aqueous alcohol solution to prepare a cellulose ether solution (S3), aging the cellulose ether solution (S4), and adding a gelation agent to the resultant (S5).

In the process (S2), the heating of the aqueous alcohol solution may be performed from room temperature (20° C. to 30° C.) to a temperature of 40° C. to 70° C. The process (S2) is performed to allow the water-soluble cellulose ether to be dispersed well in the aqueous alcohol solution in the process (S3) so that the water-soluble cellulose ether is easily dissolved without aggregation. When the heating temperature is within this range, the gelation agent (and optionally, gelation aid) may have high capsule moldability without solidification, and an aqueous composition for preparing a hard capsule may be obtained that minimizes increases in the energy costs associated with inevitable heating.

The process (S3) may be performed by slowly adding the water-soluble cellulose ether to the heated aqueous alcohol solution while stirring (for example, 300 rpm).

However, the present invention is not limited thereto. For example, instead of the processes (S1 to S3), the water-soluble cellulose ether may be dissolved in water (or an alcohol) to prepare a first cellulose ether solution, and then an alcohol (or water) may be added to the first cellulose ether solution to prepare a second cellulose ether solution. Also, in this case, heated water and/or heated alcohol may be used in the preparation of the cellulose ether solution, or water-soluble cellulose ether may be dissolved in water (or an alcohol) to prepare a first cellulose ether solution, and then the first cellulose ether solution may be heated and an alcohol (or water) may be added thereto to prepare a second cellulose ether solution.

The aging process (S4) of the cellulose ether solution may be performed at a temperature of 40 to 70° C. for 2 to 12 hours. When the aging process (S4) is performed for this time range (hence, aging time), bubbles may be sufficiently removed from the resultant and a composition of the resultant may be uniform.

In the process (S4), a gelation aid and/or other additives (e.g., plasticizer, emulsifier, and the like) in addition to the gelation agent may be further added to the resultant.

At least one process of the processes (S1 to S5) may be performed while stirring.

The process (S5) may be additionally followed by removing bubbles from the aqueous composition for preparing a hard capsule. This process (S5) may be performed by stirring.

The functions, types, and the amounts of the alcohol, the water-soluble cellulose ether, the gelation agent, the gelation aid, the plasticizer, and the emulsifier are as described above, and thus explanations thereof will be omitted herein.

Herein, the present invention is described in detail with reference to examples, but is not limited to the examples.

### MODE OF THE INVENTIVE CONCEPT

### EXAMPLES

### Examples 1 to 4 and Comparative Examples 1 and 2

(Preparation of aqueous composition for preparing a hard capsule)

Ethanol was mixed with water (purified water) at ratios shown in Table 1 below to prepare aqueous ethanol solutions. Thereafter, each of the aqueous ethanol solutions was heated to a temperature shown in Table 1, and then hydroxypropyl methylcellulose (HPMC) (available from Samsung Fine Chemical Co., Ltd., AW4) was added to the aqueous ethanol solution in a ratio shown in Table 1 below and dissolved therein. Then, K-Carrageenan (available from Korea Carragheen Co., Ltd, HG404) as a gelation agent and potassium chloride as a gelation aid were added to the resultant at ratios shown in Table 1 below to obtain an aqueous composition for preparing a hard capsule.

TABLE 1

| | | | | | | Temperature |
|---|---|---|---|---|---|---|
| | | | | K- | Potassium | of |
| | Water | Ethanol | HPMC | Carrageenan | chloride | aqueous |
| | (parts by | (parts by | (parts by | (parts by | (parts by | ethanol |
| | weight*1) | weight*1) | weight*1) | weight*2) | weight*2) | solution (° C.) |
| Example 1 | 65 | 15 | 20 | 1.5 | 0 | 60 |
| Example 2 | 65 | 15 | 20 | 1.0 | 0.05 | 60 |
| Example 3 | 65 | 15 | 20 | 0.7 | 0.2 | 60 |
| Example 4 | 65 | 15 | 20 | 0.5 | 0.3 | 60 |
| Comparative | 80 | 0 | 20 | 1.0 | 0.5 | 60 |
| Example 1 | | | | | | |
| Comparative | 80 | 0 | 20 | 0.5 | 0.3 | 60 |
| Example 2 | | | | | | |

*1based on 100 parts by weight of (water + ethanol + HPMC)
*2based on 100 parts by weight of HPMC

(Preparing film)

Each aqueous composition for preparing a hard capsule maintained at a temperature of 60° C. was coated on a glass substrate by using a film caster (self-manufactured by Samsung Fine Chemicals Co., Ltd). Then, the glass substrate coated with the aqueous composition for preparing a hard capsule was dried at room temperature (25° C.) for 24 hours to obtain a film having a thickness of 100 μm. However, the aqueous composition for preparing a hard capsule prepared in Comparative Example 2 did not have sufficient gelation ability to form a film.

(Preparing a Hard Capsule)

A room temperature (25° C.) metal mold pin (size 0) was immersed in each aqueous composition for preparing a hard capsule (a temperature of the composition: 60° C.) to coat each aqueous composition for preparing a hard capsule on the mold pin. Then, the mold pin was taken out from the each aqueous composition for preparing a hard capsule and then dried at a temperature of 30° C. for 45 minutes to prepare a hard capsule. However, the aqueous composition for preparing a hard capsule prepared in Comparative Example 2 did not have sufficient gelation ability to form a hard capsule.

### Evaluation Example

Gel strength of the aqueous compositions for preparing a hard capsule prepared in Examples 1 to 4 and Comparative Examples 1 and 2, tensile strength and hardness of the films prepared in Examples 1 to 4 and Comparative Example 1, and haze of the hard capsules (hence, capsule films) prepared in Examples 1 to 4 and Comparative Example 1 were measured by using the following method, and the results are shown in Table 2 below.

(Evaluation Method of Gel Strength of Aqueous Composition for Preparing a Hard Capsule)

The each aqueous composition for preparing a hard capsule maintained at a temperature of 60° C. was cooled to room temperature (about 25° C.) and gelled. Then, a Texture Analyser (Brookfield, CT3-4500, Probe No: TA10) was used to measure strength of a gel formed from the each aqueous composition for preparing a hard capsule. However, the aqueous composition for preparing a hard capsule prepared in Comparative Examples 1 and 2 did not have sufficient gelation ability to form a gel and thus, the gel strength could not be measured.

(Evaluation Method of Tensile Strength and Hardness of Film)

Each of the films were cut into a size of 1 cm×10 cm and then a LLOYD Instrument testing machine (LRX plus, available from LLOYD Instrument, UK) was used to measure tensile strength of the each film. Also, each of the films was cut into a size of 4 cm×5 cm and then a Texture Analyzer (Brookfield, CT3-4500, Probe No. TA-39) was used to measure hardness of the each film.

(Evaluation Method of Haze of Hard Capsule)

The hard capsules prepared in Examples 1 to 4 and Comparative Example 1 were each put into a 40 mL vial and then maintained at a temperature of 40° C., 75% RH (relative humidity) condition for 4 weeks. Then, light having a wavelength of 420 nm was irradiated from a UV spectrophotometer (JASCO, V-550) to each hard capsule to measure light transmittance. Here, the higher the light transmittance, the lower the haze.

TABLE 2

| | Gel strength of | | | Properties of |
|---|---|---|---|---|
| | aqueous | Properties of film | | hard capsule |
| | composition for | Tensile | | Light |
| | preparing hard | strength | | transmittance |
| | capsule (g) | (N/mm2) | Hardness (g) | (%) |
| Example 1 | 120 | 66 | 3,250 | 96 |
| Example 2 | 118 | 64 | 3,190 | 94 |
| Example 3 | 115 | 60 | 3,205 | 92 |
| Example 4 | 116 | 60 | 3,120 | 91 |
| Comparative | Not measurable | 52 | 2,640 | 51 |
| Example 1 | | | | |

Referring to Table 2 above, the films prepared in Examples 1 to 4 showed higher tensile strength and hardness than the film prepared in Comparative Example 1. Also, the hard capsules prepared in Examples 1 to 4 showed higher light transmittance than the hard capsule prepared in Comparative Example 1.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A hard capsule comprising:
a water-soluble cellulose ether and a gelation agent, wherein
an amount of the gelation agent is about 0.5 parts by weight to about 1.5 parts by weight based on 100 parts by weight of the water-soluble cellulose ether, and
further comprising 0 parts by weight to about 0.3 parts by weight of a gelation aid based on 100 parts by weight of the water-soluble cellulose ether.

2. The hard capsule of claim 1, wherein the hard capsule further comprises 0 parts by weight to about 5 parts by weight of other additives based on 100 parts by weight of the water-soluble cellulose ether.

3. The hard capsule of claim 1, wherein the water-soluble cellulose ether comprises hydroxypropyl methylcellulose (HPMC), hydroxyethyl methylcellulose (HEMC), methylcellulose (MC), or a mixture of two or more of these.

4. The hard capsule of claim 1, wherein the gelation agent comprises Carrageenan, Gellan gum, Xanthan gum, Pectin, or a mixture of two or more of these.

5. The hard capsule of claim 1, wherein the gelation aid comprises potassium chloride, potassium acetate, calcium chloride, or a mixture of two or more of these.

6. The hard capsule of claim 2, wherein the other additives comprise a plasticizer, an emulsifier, or a mixture of two or more of these.
